(19) United States
(12) Patent Application Publication
(10) Pub. No.: US 2021/0207790 A1
(43) Pub. Date: Jul. 8, 2021

(54) FLEXIBLE STRUCTURE WITH LIGHT EMITTING NET COVER

(71) Applicant: COOLGENETEK LTD., NEW TAIPEI CITY (TW)

(72) Inventor: Yung-Lin HSU, NEW TAIPEI CITY (TW)

(21) Appl. No.: 17/141,669

(22) Filed: Jan. 5, 2021

(30) Foreign Application Priority Data
Jan. 8, 2020 (TW) 109100587

(51) Int. Cl. F21V 15/01; F21V 33/00

(52) U.S. Cl. CPC F21V 15/012; F21Y 2115/10; F21V 33/0008

(57) ABSTRACT

A flexible structure with a light emitting net cover is provided. The flexible structure (10) includes a flexible carrier (1) and a light emitting net cover (2). The flexible carrier (1) includes an opening (11) and is composed of a leather, a fabric, a silicone, or a rubber material. The light emitting net cover (2) includes a light guiding net (21) and a light emitting module (22). The light guiding net (21) is fixed on the flexible carrier (1) and includes a weaving net portion (212) that is woven by multiple optical fibers (211) and the weaving net portion (212) covers the opening (11). The light emitting module (22) includes a LED (221) arranged correspondingly to the plurality of optical fibers (211). The purpose of the flexible structure (10) having special visual effect such as meshed light effect may be achieved.

### BACKGROUND OF THE INVENTION

### Technical Field

The present invention relates to a flexible material product installed with light emitting net cover, and particularly relates to a flexible structure with a light emitting net cover.

### Related Art

As personalized and diverse style is prompted, the products like clothes, bag, gloves, hat, etc., also require special and novel visual effects. Thus, how to design the flexible products (for example, clothes, bag, gloves, hat, etc.) with light emitting function is the key feature of present invention.

Accordingly, the applicant of the present invention has devoted himself for improving the mentioned disadvantages.

### SUMMARY OF THE INVENTION

The present invention provides a flexible structure with a light emitting net cover. The flexible structure uses light emitting diode (LED) for transmitting light to a plurality of optical fibers. As a result, the weaving net portion may present visual perception with meshed light effect and further achieve the purpose of the flexible structure having special visual effect such as meshed light effect.

In some embodiments of present invention, a flexible structure with a light emitting net cover is provided. The flexible structure includes: a flexible carrier including at least one opening and composed of a leather, a fabric, a silicone or a rubber material; and at least one light emitting net cover including: a light guiding net fixed on the flexible carrier and including a weaving net portion, wherein the weaving net portion is woven by a plurality of optical fibers and covering the opening; and a light emitting module including at least one LED arranged correspondingly to the plurality of optical fibers.

In summary, the weaving net portion covers the opening of the flexible carrier and the LED transmits light to whole of the weaving net portion through the plurality of optical fibers. As a result, the opening of the flexible carrier may present visual perception with meshed light effect. A shape of the opening may be at least one of a pattern, a word, a symbol, or a combination thereof. Further, the aesthetic appearance and decoration of the flexible carrier may be improved.

Moreover, the weaving net portion includes a plurality of warp-wise optical fibers and a plurality of weft-wise light transmitting yarns woven as warp and weft. The weaving net portion may have woven fabric texture. The weft-wise light transmitting yarns have light permeable function and the light of the LED may transmit stably to whole of the weaving net portion. The light emitting efficiency of the weaving net portion may be increased.

### BRIEF DESCRIPTION OF THE DRAWINGS

FIG. 1 is a schematic view illustrating an operating status of the light emitting net cover in present invention;

FIG. 2 is a partial enlarged view of the first embodiment of the weaving net portion in present invention;

FIG. 3 is a partial enlarged view of the second embodiment of the weaving net portion in present invention;

FIG. 4 is a schematic view illustrating an operating status of another embodiment of the light emitting net cover in present invention;

FIG. 5 is a partial enlarged view of the third embodiment of the weaving net portion in present invention;

FIG. 6 is a schematic view illustrating an operating status of the other embodiment of the light emitting net cover in present invention;

FIG. 7 is a schematic view illustrating a combination of the flexible structure in present invention; and

FIG. 8 is a schematic view illustrating a combination of another embodiment of the flexible structure in present invention.

### DETAILED DESCRIPTION OF THE INVENTION

The embodiments of the present invention will be described with reference to the drawings. These are, of course, merely examples and are not intended to be limiting.

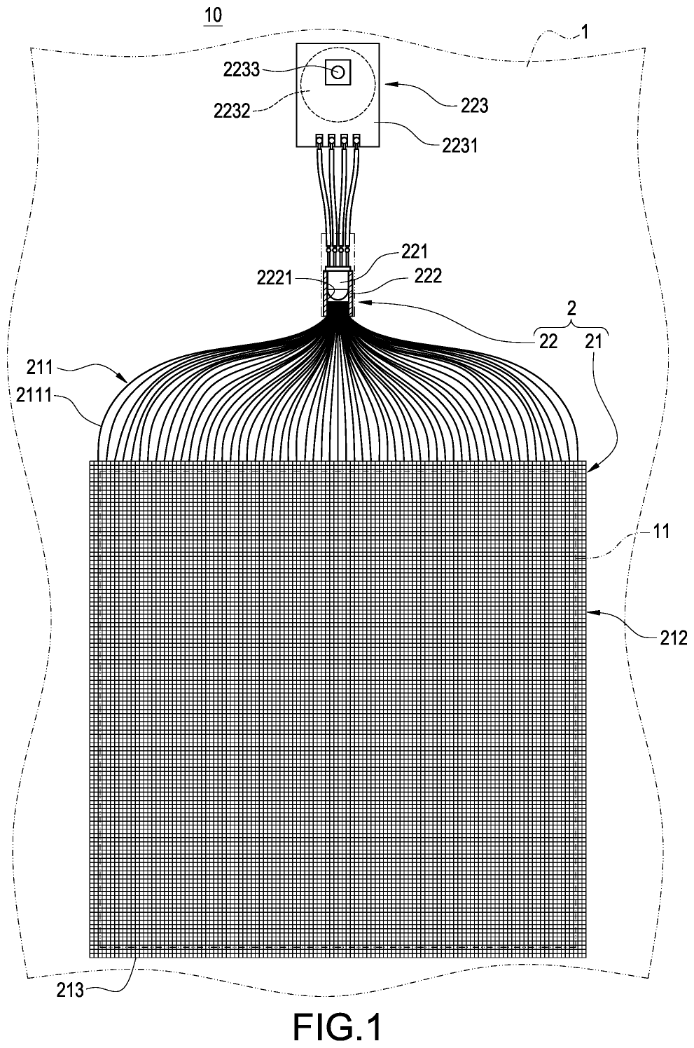

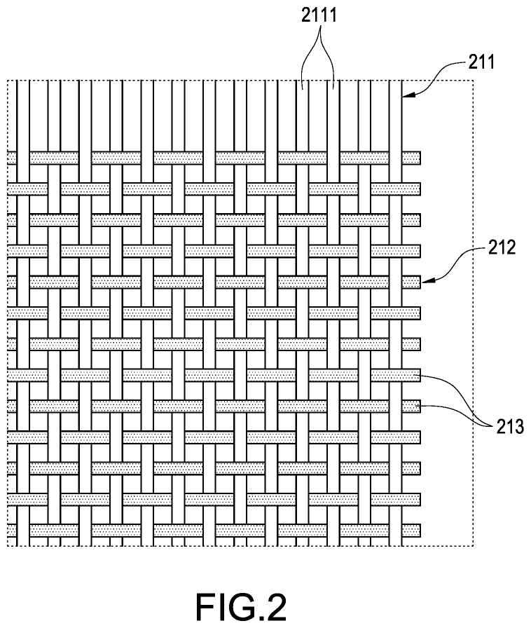

Referring to FIG. 1 and FIG. 2, a flexible structure with a light emitting net cover is provided in present invention. The flexible structure 10 includes a flexible carrier 1 and one or multiple light emitting net covers 2.

Referring to FIG. 1, the flexible carrier 1 may be composed of flexible materials; the flexible material is for example but not limited to, a leather, a fabric, a silicone, or a rubber, etc. The flexible carrier 1 is disposed with one or multiple openings 11. The shape of the opening 11 may be at least one of a pattern, a word, a symbol, or a combination thereof. In some embodiments, an amount of the opening 11 is, but not limited to, one.

Referring to FIG. 2, the light emitting net cover 2 includes a light guiding net 21 and a light emitting module 22. The light guiding net 21 is fixed on the flexible carrier 1. The light guiding net 21 includes a weaving net portion 212. The weaving net portion 212 is woven by a plurality of optical fibers 211, and the weaving net portion 212 covers the opening 11. The light emitting module 22 includes one or multiple LEDs 221 arranged correspondingly to the plurality of optical fibers 211.

Specifically, FIG. 2 is the first embodiment of the weaving net portion 212 in present invention. In some embodiments, the multiple optical fibers 211 is multiple warp-wise optical fibers 2111 arranged parallelly in warp-wise. The light guiding net 21 further includes multiple weft-wise light transmitting yarns 213 arranged parallelly in weft-wise. The multiple warp-wise optical fibers 2111 and the multiple weft-wise light transmitting yarns 213 are woven as warp and weft to form the weaving net portion 212. The weft-wise light transmitting yarns 213 may be, but not limited to, voile.

In some embodiments, an amount of the LED 221 is one. In some embodiments, the light emitting module 22 further includes a fixing bushing 222 and a power controlling element 223. One end of the fixing bushing 222 is disposed at (or sheathes) terminals of the plurality of warp-wise optical fibers 2111, and terminals of the plurality of warp-wise optical fibers 2111 are tightened (packed) by the end of the fixing bushing 222. Another end of the fixing bushing 222 connects (or sockets) with the LED 221. The LED 221 is electrically connected to the power controlling element 223.

The fixing bushing 222 may be composed of metal material, or an inner periphery of the fixing bushing 222 may be covered by a light reflecting layer. Thus, the inner periphery of the fixing bushing 222 may have a light reflecting inner wall 2221. The light of the LED 221 may be reflected by the light reflecting inner wall 2221 to be stably transmitted to the multiple optical fibers 211.

Moreover, in some embodiments, the power controlling element 223 includes, but not limited to, a circuit board 2231 electrically connected with the LED 221, a battery 2232 installed on the circuit board 2231 and a switch 2233. The circuit board 2231 senses the pressing of the switch 2233 for determining either provide power to the LED 221 or disconnect power from the LED 221. The LED 221 is thus controlled to be lit up or extinguished.

Referring to FIG. 1 and FIG. 2, the operation status of the flexible structure 10 is illustrated. The weaving net portion 212 is used to cover the opening 11 of the flexible carrier 1. The LED 221 transmits the light through the multiple optical fibers 211 to whole of the weaving net portion 212. As a result, the opening 11 of the flexible carrier 1 may present visual perception with meshed light effect. A shape of the opening 11 may be at least one of a pattern, a word, a symbol, or a combination thereof. Further, the aesthetic appearance and decoration of the flexible carrier 1 may be improved.

In some embodiments, the weaving net portion 212 includes a plurality of warp-wise optical fibers 2111 and a plurality of weft-wise light transmitting yarns 213 woven as warp and weft. The weaving net portion 212 may have woven fabric texture. The weft-wise light transmitting yarns 213 have light permeable function and the light of the LED 221 may transmit stably to whole of the weaving net portion 212. The light emitting efficiency of the weaving net portion 212 may be increased.

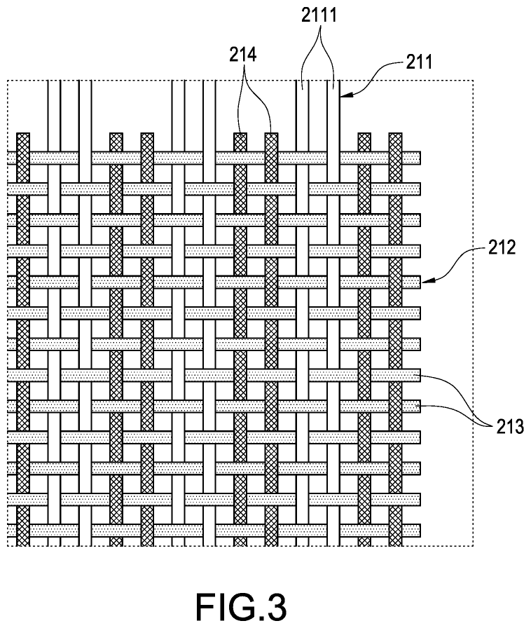

Referring to FIG. 3, the second embodiment of the weaving net portion 212 in present invention is illustrated. The embodiment in FIG. 3 is similar to the embodiment in FIG. 1 and FIG. 2. The difference between the embodiment in FIG. 3 and the embodiment in FIG. 1 and FIG. 2 is that the light guiding net 21 further includes a plurality of warp-wise light reflecting yarns 214 arranged parallelly in warp-wise. The plurality of warp-wise light reflecting yarns 214 and the plurality of warp-wise optical fibers 2111 are interweaved parallelly. The plurality of warp-wise light reflecting yarns 214 and the plurality of weft-wise light transmitting yarns 213 are woven as warp and weft to form the weaving net portion 212. The warp-wise light reflecting yarns 214 are composed of high tenacity yarns with glass light reflecting particles (glitters) adhered on the outer surface.

The plurality of warp-wise light reflecting yarns 214 and the plurality of warp-wise optical fibers 2111 are interweaved parallelly for the warp-wise light reflecting yarns 214 reflecting the light refracted by the warp-wise optical fibers 2111. Further, the warp-wise light reflecting yarns 214 and the warp-wise optical fibers 2111 are arranged parallelly to prevent from blocking the light transmission of the warp-wise optical fibers 2111. The light emitting efficiency of the weaving net portion 212 may be increased.

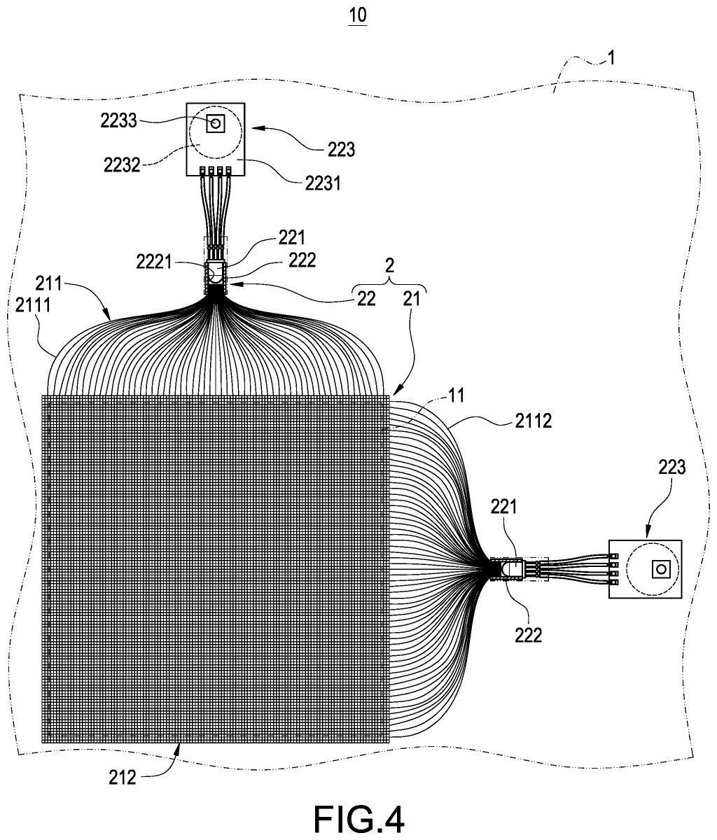

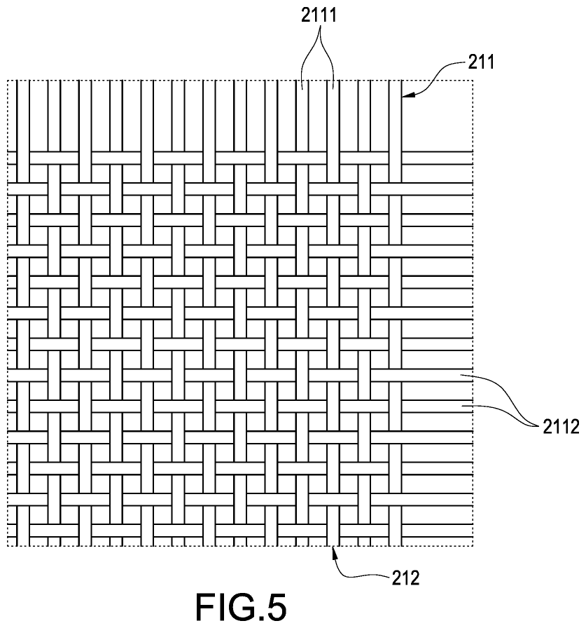

Referring to FIG. 4 and FIG. 5, another embodiment of the light emitting net cover 2 and the third embodiment of the weaving net portion 212 in present invention is illustrated. The embodiment in FIG. 4 and FIG. 5 is similar to the embodiment in FIG. 1 and FIG. 2. The difference between the embodiment in FIG. 4 and FIG. 5 and the embodiment in FIG. 1 and FIG. 2 is that the plurality of optical fibers 211 are divided into a plurality of warp-wise optical fibers 2111 and a plurality of weft-wise optical fibers 2112. The plurality of warp-wise optical fibers 2111 and the plurality of weft-wise optical fibers 2112 are woven as warp and weft to form the weaving net portion 212.

Specifically, with the plurality of optical fibers 211 being divided into the plurality of warp-wise optical fibers 2111 and the plurality of weft-wise optical fibers 2112, the amounts of the LED 221, fixing bushing 222 and power controlling element 223 are two respectively. One end of one of the fixing bushings 222 is disposed at (or sheathes) terminals of the plurality of warp-wise optical fibers 2111, and terminals of the plurality of warp-wise optical fibers 2111 are tightened (packed) by the same end of the fixing bushing 222. Another end of one of the fixing bushing 222 connects (or sockets) with one of the LEDs 221. One end of another one of the fixing bushings 222 is disposed at (or sheathes) terminals of the plurality of weft-wise optical fibers 2112, and terminals of the plurality of weft-wise optical fibers 2112 are tightened (packed) by the same end of the fixing bushing 222. Another end of another one of the fixing bushing 222 connects (or sockets) with another one of the LEDs 221. Each of the LEDs 221 is electrically connected to each of the power controlling elements 223 respectively. Thus, the multiple warp-wise optical fibers 2111 and the multiple weft-wise optical fibers 2112 are woven as warp and weft, and the meshed light effect brightness may be increased.

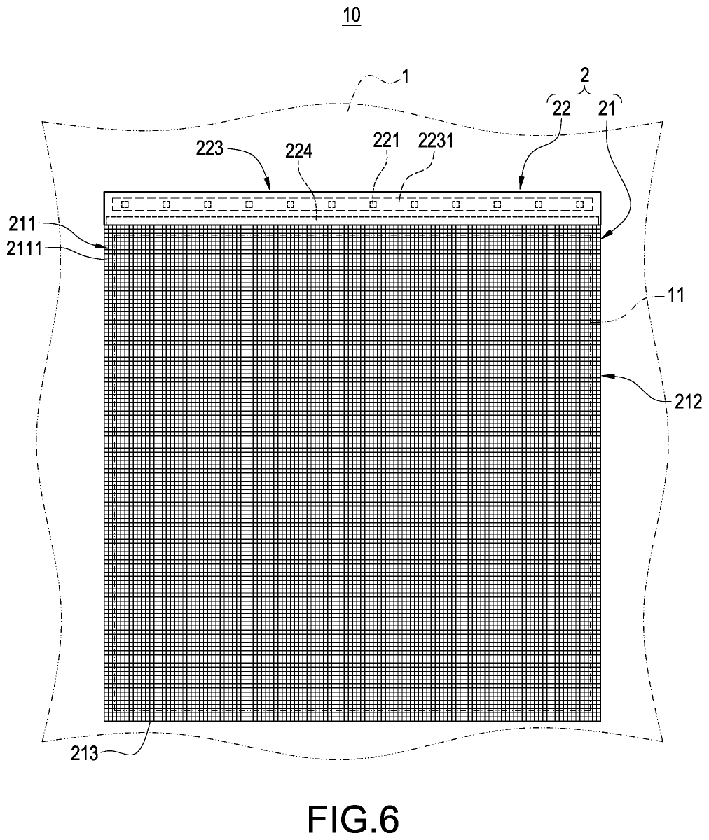

Referring to FIG. 6, the other embodiment of the light emitting net cover 2 in present invention is illustrated. The embodiment in FIG. 6 is similar to the embodiment in FIG. 1 and FIG. 2. The difference between the embodiment in FIG. 6 and the embodiment in FIG. 1 and FIG. 2 is that the structure of the light emitting module 22 is different.

Specifically, in some embodiments, the amount of the LED 221 is multiple. In some embodiments, the light emitting module 22 further includes a flexible light guiding bar 224 and a power controlling element 223. The plurality of warp-wise optical fibers 2111 are formed by extending from one side of the flexible light guiding bar 224. The power controlling element 223 and the flexible light guiding bar 224 are fixed and connected with each other. The plurality of LEDs 221 are electrically connected to the power controlling element 223 and disposed correspondingly to the flexible light guiding bar 224.

Similarly, referring back to FIG. 4 and FIG. 5, in some embodiments, when the plurality of optical fibers 211 are divided into the plurality of warp-wise optical fibers 2111 and the plurality of weft-wise optical fibers 2112, the amount of the flexible light guiding bar 224 and the power controlling element 223 are two respectively. The plurality of warp-wise optical fibers 2111 are formed by extending from one side of one of the flexible light guiding bars 224. The plurality of weft-wise optical fibers 2112 are formed by extending from one side of another one of the flexible light guiding bars 224. Each of the power controlling elements 223 and each of the flexible light guiding bars 224 are fixed and connected with each other. The plurality of LEDs 221 are electrically connected to each of the power controlling elements 223 and disposed correspondingly to each of the flexible light guiding bars 224.

As a result, the multiple LEDs 221 may stably transmit light to the multiple optical fibers 211 through the flexible light guiding bar 224. The light emitting efficiency of the weaving net portion 212 may be increased.

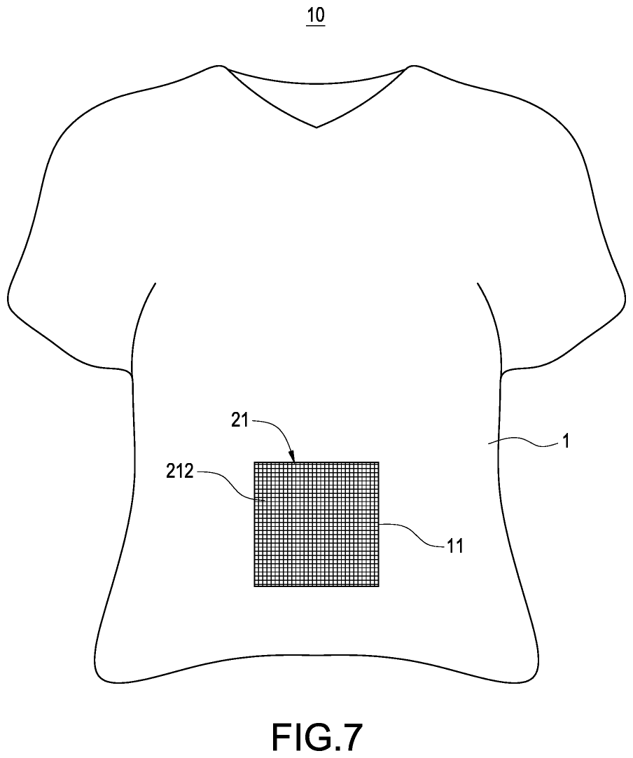

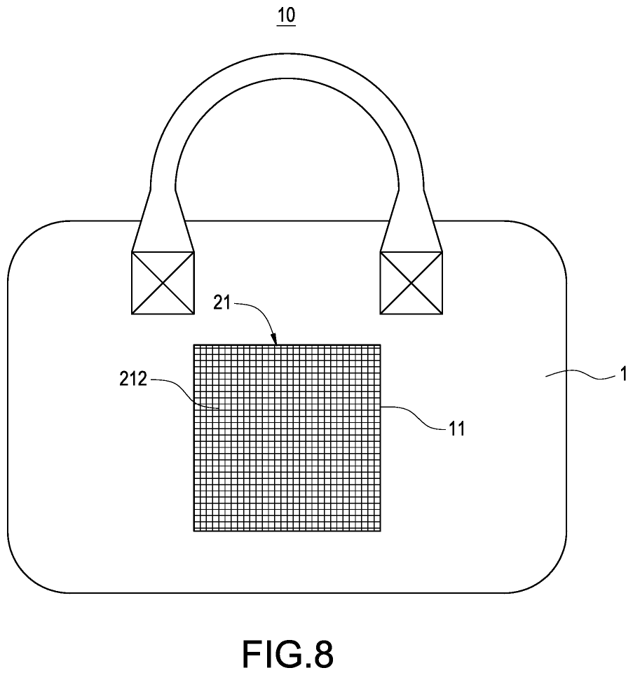

Referring to FIG. 7 and FIG. 8, a combination of the flexible structure 10 in present invention is illustrated. The flexible carrier 1 may be applied broadly. The flexible carrier 1 may be a shirt, a pants, a skirt, a hat, a scarf, or a bag, etc., flexible material products.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A flexible structure with a light emitting net cover, the flexible structure comprising:
a flexible carrier (1), comprising at least one opening (11) and composed of a leather, a fabric, a silicone, or a rubber material; and
at least one light emitting net cover (2), comprising:
a light guiding net (21), fixed on the flexible carrier (1) and comprising a weaving net portion (212), wherein the weaving net portion (212) is woven by a plurality of optical fibers (211) and covers the opening (11); and
a light emitting module (22), comprising at least one LED (221) arranged correspondingly to the plurality of optical fibers (211).

2. The flexible structure with the light emitting net cover of claim 1, wherein the plurality of optical fibers (211) comprises a plurality of warp-wise optical fibers (2111), the light guiding net (21) further comprises a plurality of weft-wise light transmitting yarns (213), and the weaving net portion (212) is woven as warp and weft by the plurality of warp-wise optical fibers (2111) and the plurality of weft-wise light transmitting yarns (213).

3. The flexible structure with the light emitting net cover of claim 2, wherein the light guiding net (21) further comprises a plurality of warp-wise light reflecting yarns (214) interweaved parallelly with the plurality of warp-wise optical fibers (2111), and the weaving net portion (212) is woven as warp and weft by the plurality of warp-wise light reflecting yarns (214) and the plurality of weft-wise light transmitting yarns (213).

4. The flexible structure with the light emitting net cover of claim 2, wherein an amount of the LED (221) is one, the light emitting module (22) further comprises a fixing bushing (222) and a power controlling element (223), one end of the fixing bushing (222) is disposed at terminals of the plurality of warp-wise optical fibers (2111) and another end of the fixing bushing (222) connects with the LED (221), and the LED (221) is electrically connected to the power controlling element (223).

5. The flexible structure with the light emitting net cover of claim 4, wherein the fixing bushing (222) comprises a light reflecting inner wall (2221).

6. The flexible structure with the light emitting net cover of claim 2, wherein an amount of the LED (221) is multiple, the light emitting module (22) further comprises a flexible light guiding bar (224) and a power controlling element (223), the plurality of warp-wise optical fibers (2111) is extended from one side of the flexible light guiding bar (224), the power controlling element (223) and the flexible light guiding bar (224) are connected with each other, the plurality of LEDs (221) are electrically connected to the power controlling element (223) and disposed correspondingly to the flexible light guiding bar (224).

7. The flexible structure with the light emitting net cover of claim 1, wherein the plurality of optical fibers (211) comprises a plurality of warp-wise optical fibers (2111) and a plurality of weft-wise optical fibers (2112), and the weaving net portion (212) is woven as warp and weft by the plurality of warp-wise optical fibers (2111) and the plurality of weft-wise optical fibers (2112).

8. The flexible structure with the light emitting net cover of claim 7, wherein an amount of the LED (221) is two, the light emitting module (22) further comprises two fixing bushings (222) and two power controlling elements (223), one end of one of the fixing bushings (222) is disposed at terminals of the plurality of warp-wise optical fibers (2111) and another end of one of the fixing bushings (222) connects with one of the LEDs (221), one end of another one of the fixing bushings (222) is disposed at terminals of the plurality of weft-wise optical fibers (2112) and another end of another one of the fixing bushings (222) connects with another one of the LEDs (221), and each of the LEDs (221) is electrically connected to each of the power controlling elements (223) respectively.

9. The flexible structure with the light emitting net cover of claim 8, wherein each of the fixing bushing (222) comprises a light reflecting inner wall (2221).

10. The flexible structure with the light emitting net cover of claim 7, wherein an amount of the LED (221) is multiple, the light emitting module (22) further comprises two flexible light guiding bars (224) and two power controlling elements (223), the plurality of warp-wise optical fibers (2111) are extended from one side of one of the flexible light guiding bars (224), the plurality of weft-wise optical fibers (2112) are extended from one side of another one of the flexible light guiding bars (224), each of the power controlling element (223) and each of the flexible light guiding bar (224) are connected with each other, the plurality of LEDs (221) are electrically connected to each of the power controlling element (223) respectively and disposed correspondingly to each of the flexible light guiding bar (224).

11. The flexible structure with the light emitting net cover of claim 1, wherein a shape of the opening (11) comprises at least one of a pattern, a word or a symbol, and the flexible carrier (1) comprises a shirt, a pants, a skirt, a hat, a scarf, or a bag.
